(19) United States
(12) Patent Application Publication
(10) Pub. No.: US 2017/0163978 A1
(43) Pub. Date: Jun. 8, 2017

(54) SYSTEM AND METHOD FOR SYNCHRONIZING AUDIO SIGNAL AND VIDEO SIGNAL

(71) Applicant: Electronics and Telecommunications Research Institute, Daejeon (KR)

(72) Inventors: Mi Suk LEE, Daejeon (KR); Kyeong Ok KANG, Daejeon (KR); Tae Jin PARK, Daejeon (KR); Seung Kwon BEACK, Daejeon (KR); Sang Won SUH, Daejeon (KR); Jong Mo SUNG, Daejeon (KR); Tae Jin LEE, Daejeon (KR)

(73) Assignee: Electronics and Telecommunications Research Institute, Daejeon (KR)

(21) Appl. No.: 15/228,333

(22) Filed: Aug. 4, 2016

(30) Foreign Application Priority Data
Dec. 8, 2015 (KR) 10-2015-0174324

(51) Int. Cl. H04N 17/00; H04N 21/43; H04N 21/8547; H04N 19/467; H04N 19/577; H04N 19/44; H04N 21/8358; H04N 19/593; H04N 19/52; H04N 21/242; H04N 19/85

(52) U.S. Cl. CPC H04N 17/004; H04N 21/242; H04N 21/4305; H04N 21/8547; H04N 19/467; H04N 19/85; H04N 19/44; H04N 21/8358; H04N 19/593; H04N 19/52; H04N 19/577

(57) ABSTRACT

A system and method for synchronizing an audio signal and a video signal are provided. A decoding method in the system may include decoding an audio signal and a video signal received from an encoding apparatus, extracting first unique information of the audio signal from the decoded video signal, generating second unique information of the audio signal based on the decoded audio signal, determining a delay between the audio signal and the video signal by comparing the first unique information to the second unique information, and synchronizing the audio signal and the video signal based on the delay. The first unique information may be generated based on an audio signal that is not encoded by the encoding apparatus, and may be inserted into the video signal.

### CROSS-REFERENCE TO RELATED APPLICATION

This application claims the benefit under 35 USC §119(a) of Korean Patent Application No. 10-2015-0174324, filed on Dec. 8, 2015, in the Korean Intellectual Property Office, the entire disclosure of which is incorporated herein by reference for all purposes.

### BACKGROUND

1. Field of the Invention

The following description relates to a system and method for synchronizing an audio signal and a video signal in an encoding apparatus and/or a decoding apparatus.

2. Description of the Related Art

A service for broadcasting a continuous audio signal and a continuous video signal in real time is being provided. In the service, to transmit the audio signal and the video signal, a transmitter needs to encode the audio signal and the video signal. A receiver needs to decode the audio signal and the video signal received from the transmitter and play the audio signal and the video signal.

However, even though the transmitter synchronizes the audio signal and the video signal, the audio signal or the video signal may be delayed during the encoding, the decoding or the transmitting. Also, because the audio signal and the video signal played by the receiver are not synchronized, a quality of the service may be reduced.

Thus, there is a desire for a method of automatically synchronizing an audio signal and a video signal by detecting a delay between the audio signal and the video signal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments provide a method and apparatus for preventing a problem from occurring due to a delay of a video signal or an audio signal.

In one general aspect, a decoding method includes decoding an audio signal and a video signal received from an encoding apparatus, extracting first unique information of the audio signal from the decoded video signal, generating second unique information of the audio signal based on the decoded audio signal, determining a delay between the audio signal and the video signal by comparing the first unique information to the second unique information, and synchronizing the audio signal and the video signal based on the delay. The first unique information may be generated based on an audio signal that is not encoded by the encoding apparatus, and may be inserted into the video signal.

The determining of the delay may include searching for second unique information matched to the first unique information from the generated second unique information and determining, as the delay, a difference between a frame of the audio signal used to generate the found second unique information and a frame of the video signal from which the first unique information is extracted.

A frame of the video signal into which the first unique information is inserted may be determined based on an interval between frames based on a feature of the audio signal and the video signal.

An amount of the first unique information inserted into the video signal may be determined based on a feature of the audio signal and the video signal.

The first unique information may be inserted into a unidirectionally predicted frame (P-frame) or a bidirectionally predicted frame (B-frame) of the video signal based on an encoding feature of the video signal.

In another general aspect, a decoding method includes decoding an audio signal and a video signal received from an encoding apparatus, extracting first unique information of the audio signal from the decoded video signal, extracting first unique information of the video signal from the decoded audio signal, generating second unique information of the audio signal based on the decoded audio signal, generating second unique information of the video signal based on the decoded video signal, determining a delay between the audio signal and the video signal by comparing the first unique information of the audio signal to the second unique information of the audio signal and by comparing the first unique information of the video signal to the second unique information of the video signal, and synchronizing the audio signal and the video signal based on the delay.

A frame of the audio signal into which the first unique information of the video signal is inserted may be determined based on an interval of frames based on a feature of the audio signal and the video signal.

An amount of the first unique information of the video signal inserted into the audio signal may be determined based on a feature of the audio signal and the video signal.

In still another general aspect, an encoding method includes generating first unique information of an audio signal based on the audio signal, inserting the first unique information into a video signal, and encoding the audio signal and the video signal into which the first unique information is inserted.

The generating of the first unique information may include determining an interval between frames that are to be used to generate the first unique information, based on a feature of the audio signal and the video signal.

The generating of the first unique information may include determining an amount of the first unique information, based on a feature of the audio signal and the video signal.

The inserting of the first unique information may include inserting the first unique information into a unidirectionally predicted frame (P-frame) or a bidirectionally predicted frame (B-frame) of the video signal based on an encoding feature of the video signal.

In yet another general aspect, an encoding method includes generating first unique information of an audio signal based on the audio signal, generating first unique information of a video signal based on the video signal, inserting the first unique information of the audio signal into the video signal, inserting the first unique information of the video signal into the audio signal, and encoding the audio signal into which the first unique information of the video signal is inserted, and the video signal into which the first unique information of the audio signal is inserted.

The generating of the first unique information may include determining an interval between frames that are to be used to generate the first unique information of the audio signal, and an interval between frames that are to be used to generate the first unique information of the video signal, based on a feature of the audio signal and the video signal.

The generating of the first unique information may include determining an amount of the first unique information of the audio signal, and an amount of the first unique information of the video signal, based on a feature of the audio signal and the video signal.

The inserting of the first unique information of the audio signal may include inserting the first unique information of the audio signal into a unidirectionally predicted frame (P-frame) or a bidirectionally predicted frame (B -frame) of the video signal based on an encoding feature of the video signal.

Other features and aspects will be apparent from the following detailed description, the drawings, and the claims.

### BRIEF DESCRIPTION OF THE DRAWINGS

FIG. 1 is a diagram illustrating a synchronization system according to an embodiment.

FIG. 2 is a block diagram illustrating a configuration of an encoding apparatus in the synchronization system of FIG. 1.

FIG. 3 illustrates an example of an operation of the encoding apparatus in the synchronization system of FIG. 1.

FIG. 4 illustrates an example of an operation between components of the encoding apparatus in the synchronization system of FIG. 1.

FIG. 5 is a block diagram illustrating a configuration of a decoding apparatus in the synchronization system of FIG. 1.

FIG. 6 illustrates an example of an operation of the decoding apparatus in the synchronization system of FIG. 1.

FIG. 7 illustrates an example of an operation between components of the decoding apparatus in the synchronization system of FIG. 1.

FIG. 8 illustrates another example of an operation between components of the encoding apparatus in the synchronization system of FIG. 1.

FIG. 9 illustrates another example of an operation between components of the decoding apparatus in the synchronization system of FIG. 1.

FIG. 10 is a flowchart illustrating an example of an encoding method according to an embodiment.

FIG. 11 is a flowchart illustrating an example of a decoding method corresponding to the encoding method of FIG. 10 according to an embodiment.

FIG. 12 is a flowchart illustrating another example of an encoding method according to an embodiment.

FIG. 13 is a flowchart illustrating an example of a decoding method corresponding to the encoding method of FIG. 12 according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

Hereinafter, embodiments will be further described with reference to the accompanying drawings. An encoding method according to an embodiment may be performed by an encoding apparatus of a synchronization system. Also, a decoding method according to an embodiment may be performed by a decoding apparatus of the synchronization system.

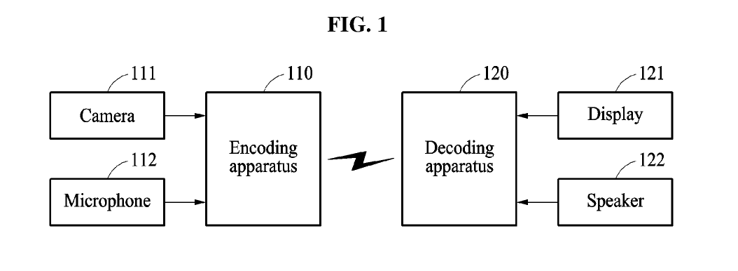

FIG. 1 is a diagram illustrating a synchronization system according to an embodiment.

Referring to FIG. 1, the synchronization system may include an encoding apparatus 110 and a decoding apparatus 120. The synchronization system may synchronize a video signal and an audio signal received through a service for transmitting an audio signal and a video signal in real time.

The encoding apparatus 110 may encode a video signal received from a camera 111 and an audio signal received from a microphone 112, and may transmit the encoded video signal and the encoded audio signal to the decoding apparatus 120.

The encoding apparatus 110 may generate first unique information of the video signal or the audio signal, based on the video signal or the audio signal. The first unique information may be, for example, a fingerprint of a person representing a unique feature of an audio signal or a video signal.

Also, the encoding apparatus 110 may insert first unique information of the video signal into the audio signal, or may insert first unique information of the audio signal into the video signal.

The encoding apparatus 110 may encode a video signal or audio signal into which first unique information is inserted, and an audio signal or video signal corresponding to the first unique information, and may transmit the encoded audio signal or the encoded video signal to the decoding apparatus 120. For example, the encoding apparatus 110 may encode the audio signal into which the first unique information of the video signal is inserted, and the video signal into which the first unique information of the audio signal is inserted.

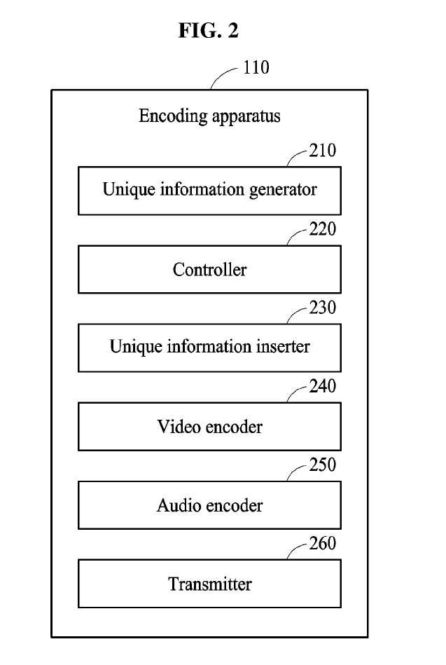

A configuration and an operation of the encoding apparatus 110 will be further described with reference to FIGS. 2, 3, 4 and 8.

The decoding apparatus 120 may decode the video signal and the audio signal received from the encoding apparatus 110.

The decoding apparatus 120 may extract the first unique information of the video signal from the audio signal or extract the first unique information of the audio signal from the video signal. Also, the decoding apparatus 120 may generate second unique information of the video signal or the audio signal based on the video signal or the audio signal.

In addition, the decoding apparatus 120 may compare the extracted first unique information to the generated second unique information, and may detect a delay between the video signal and the audio signal based on a comparison result. The decoding apparatus 120 may synchronize the video signal and the audio signal based on the detected delay and may output the video signal and the audio signal to the display 121 and the speaker 122.

The same video signal or the same audio signal may be used to generate the first unique information and the second unique information, and accordingly the first unique information and the second unique information may be the same in principle. However, the video signal or the audio signal may change during encoding, decoding and transmitting. Accordingly, the first unique information generated based on the video signal or the audio signal that is not encoded may be different from the second unique information generated based on the video signal or the audio signal that is decoded.

For example, when encoding and decoding are performed normally, a difference between the first unique information and the second unique information may be equal to or less than a margin of error. In this example, the decoding apparatus 120 may determine second unique information having a highest similarity to the first unique information among the second unique information as unique information generated based on frames of the same video signal or the same audio signal as those of the first unique information, and may match and compare the determined second unique information to the first unique information.

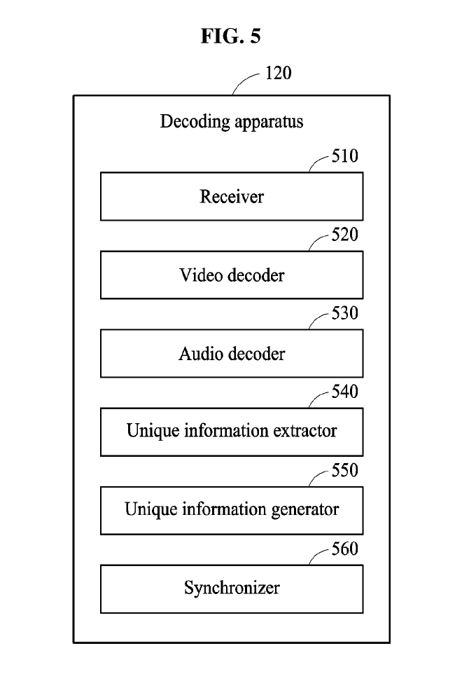

A configuration and an operation of the decoding apparatus 120 will be further described with reference to FIGS. 5, 6, 7 and 9.

In the synchronization system, the encoding apparatus 110 may insert the first unique information generated based on the audio signal into the video signal, may transmit the video signal including the first unique information to the decoding apparatus 120, and the decoding apparatus 120 may compare the first unique information extracted from the video signal to the second unique information generated based on the audio signal, may detect a delay between the video signal and the audio signal based on a comparison result, and may synchronize the video signal and the audio signal based on the delay. Thus, it is possible to prevent a problem occurring due to a delay of the video signal or the audio signal.

FIG. 2 is a block diagram illustrating a configuration of the encoding apparatus 110 of FIG. 1.

Referring to FIG. 2, the encoding apparatus 110 may include a unique information generator 210, a controller 220, a unique information inserter 230, a video encoder 240, an audio encoder 250, and a transmitter 260.

The unique information generator 210 may generate the first unique information of the audio signal based on the audio signal received from the microphone 112. Also, the unique information generator 210 may generate the first unique information of the video signal based on the video signal received from the camera 111.

The controller 220 may control at least one of an amount of unique information and an interval between frames based on a feature of the audio signal and the video signal. For example, the controller 220 may be, for example, a fingerprint controller to control the unique information generator 210 and the unique information inserter 230.

The interval between the frames may be, for example, an interval between frames that are to be used to generate unique information in an audio signal or a video signal. Also, the controller 220 may determine whether the unique information generator 210 is to generate unique information corresponding to a frame of an audio signal or a video signal based on an interval between frames.

The amount of the unique information may be, for example, an amount of unique information generated based on a frame of an audio signal or a video signal by the unique information generator 210.

An accuracy of required synchronization may vary depending on a type of content including an audio signal and a video signal.

In an example, when a video signal corresponds to an environmental documentary video and an audio signal corresponds to music or narration, a user may not recognize the video signal and the audio signal even though the video signal and the audio signal are not synchronized. In this example, a low accuracy of synchronization may be required for the synchronization system.

In another example, when a video signal corresponds to a screen of a drama or a screen of a video conference, and when an audio signal corresponds to lines of the drama or a speech of the other party in the video conference, a user may easily determine whether a mouth shape of a person shown on the screen is not matched to lines included in the audio signal. In this example, a high accuracy of synchronization may be required for the synchronization system.

When the accuracy of the synchronization required for the synchronization system increases, the controller 220 may reduce an interval between frames of an audio signal or a video signal that are to be used by the unique information generator 210 to generate unique information. When the interval between the frames is reduced, a number or a ratio of the frames determined by the controller 220 to generate unique information may increase.

Also, the controller 220 may increase an amount of unique information generated based on a frame of an audio signal or a video signal, to prevent second unique information of a frame similar to a current frame from being matched to first unique information of the current frame in the decoding apparatus 120. For example, when the amount of the unique information corresponds to 4 bits, a number of types of the unique information may be limited to “16,” and unique information of the current frame may be similar to or the same as unique information of a frame adjacent to the current frame. In this example, when the amount of the unique information increases to 8 bits, the number of the types of the unique information may increase to “256,” and a possibility that the unique information of the current frame is similar to or the same as the unique information of the frame adjacent to the current frame may decrease.

In other words, when the accuracy of synchronization required for the synchronization system increases, the controller 220 may increase an amount of unique information generated based on a frame of an audio signal or a video signal by the unique information generator 210, to prevent the second unique information of the frame similar to the current frame from being matched to the first unique information of the current frame.

Also, when the accuracy of synchronization required for the synchronization system increases, the controller 220 may increase the interval between the frames that are to be used by the unique information generator 210 to generate unique information, or may reduce an amount of unique information to be generated. Thus, it is possible to reduce consumption of resources used to generate and insert unique information.

The controller 220 may control the unique information inserter 230 to insert the first unique information of the audio signal into an intra-coded frame (I-frame) of the video signal based on an encoding feature of the video signal. Also, the controller 220 may control the unique information inserter 230 to insert the first unique information of the audio signal into a unidirectionally predicted frame (P-frame) or a bidirectionally predicted frame (B -frame) of the video signal based on the encoding feature of the video signal. The P-frame may correspond to a forward predictive encoding image, and the B-frame may correspond to bidirectional predictive encoding image.

The unique information inserter 230 may insert the first unique information of the audio signal generated by the unique information generator 210 into the video signal based on a control of the controller 220. For example, the unique information inserter 230 may use a watermarking technology to insert the first unique information of the audio signal into the video signal. In this example, the unique information inserter 230 may set the first unique information of the audio signal inserted as a watermark into the video signal to prevent a user from viewing the first unique information of the audio signal, by using the watermarking technology.

For example, when the unique information generator 210 generates the first unique information of the video signal, the unique information inserter 230 may insert the first unique information of the video signal into the audio signal. In this example, the unique information inserter 230 may use the watermarking technology to set the first unique information of the video signal inserted as a watermark into the audio signal so that a user may not listen to the first unique information of the video signal.

The video encoder 240 may encode the video signal into which the first unique information of the audio signal is inserted by the unique information inserter 230.

The audio encoder 250 may encode an audio signal corresponding to the first unique information. When the unique information generator 210 generates the first unique information of the video signal, the audio encoder 250 may encode the audio signal into which first unique information of the video signal is inserted.

The transmitter 260 may pack the video signal encoded by the video encoder 240 and the audio signal encoded by the audio encoder 250, and may transmit the packed signals to the decoding apparatus 120.

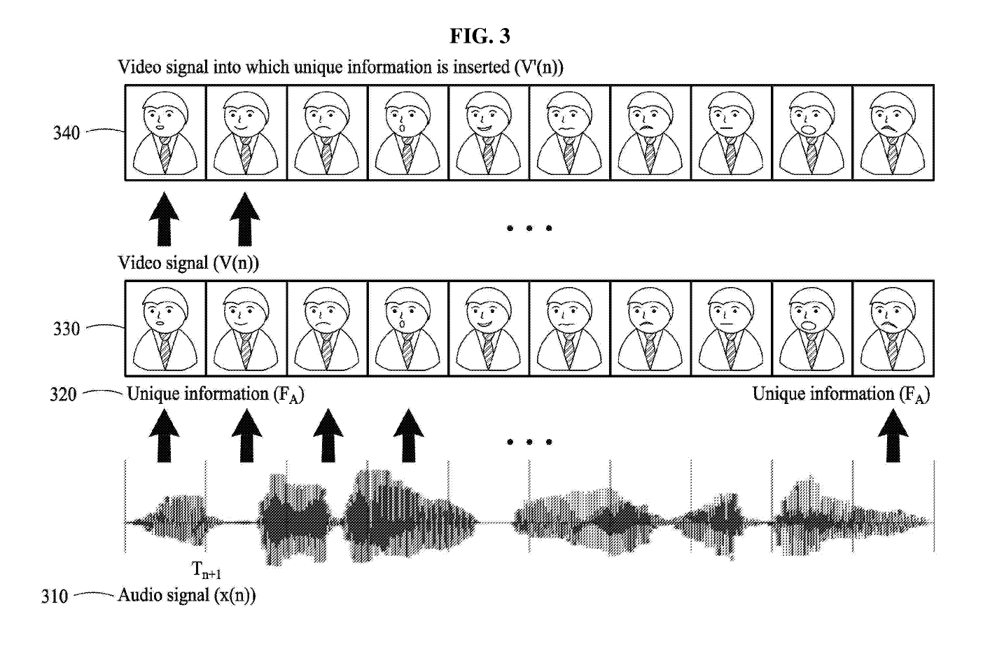

FIG. 3 illustrates an example of an operation of the encoding apparatus 110 of FIG. 1.

An audio signal x(n) 310 and a video signal v(n) 330 may be acquired through synchronization by the microphone 112 and the camera 111, respectively.

The encoding apparatus 110 may generate unique information F_{A} 320 for each of frames of the audio signal x(n) 310. The encoding apparatus 110 may insert the unique information F_{A} 320 into each of frames of the video signal v(n) 330 using a watermarking technology.

The encoding apparatus 110 may encode a video signal v′(n) 340 obtained by inserting the unique information F_{A} 320 into the video signal v(n) 330, and may transmit the video signal v′(n) 340 to the decoding apparatus 120.

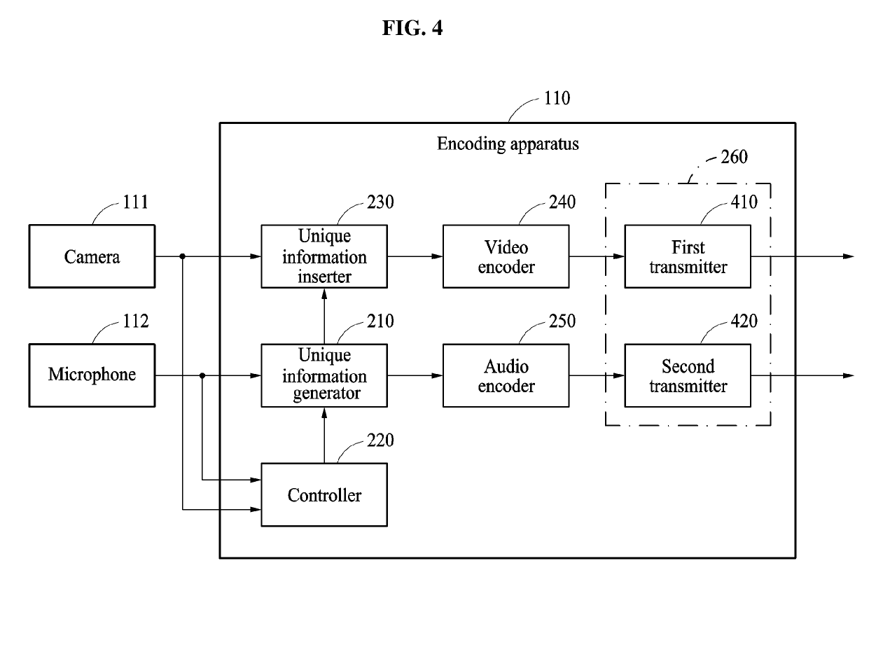

FIG. 4 illustrates an example of an operation between components of the encoding apparatus 110 of FIG. 1.

In the example of FIG. 4, first unique information of an audio signal may be inserted into a video signal.

The controller 220 may determine an amount of unique information and an interval between frames based on a feature of an audio signal received from the microphone 112 and a video signal received from the camera 111. Also, the controller 220 may determine a frame that is to be used by the unique information generator 210 to generate unique information among frames of the received audio signal based on the interval of the frames.

The unique information generator 210 may generate first unique information of the audio signal based on at least one of frames of the audio signal received from the microphone 112 based on the control of the controller 220. The unique information generator 210 may transmit the generated first unique information of the audio signal to the unique information inserter 230. Also, the unique information generator 210 may transmit, to the audio encoder 250, a frame of the audio signal used to generate unique information and a frame that is not used to generate unique information.

The unique information inserter 230 may insert the first unique information of the audio signal received from the unique information generator 210 into the video signal received from the camera 111. The unique information inserter 230 may transmit the video signal into which the first unique information of the audio signal is inserted to the video encoder 240.

The unique information inserter 230 may use the watermarking technology to insert the first unique information of the audio signal into the video signal. The unique information inserter 230 may identify a frame of the audio signal used to generate the first unique information of the audio signal, and may insert the first unique information of the audio signal into a frame of the video signal synchronized with the identified frame. For example, when a fifth frame of the audio signal is used to generate the first unique information of the audio signal, the unique information inserter 230 may insert the first unique information of the audio signal into a fifth frame of the video signal.

The audio encoder 250 may encode frames of the audio signal received from the unique information generator 210, and may transmit the encoded frames to a second transmitter 420.

The video encoder 240 may encode the video signal received from the unique information inserter 230, and may transmit the encoded video signal to a first transmitter 410.

The first transmitter 410 and the second transmitter 420 may be included in the transmitter 260. As shown in FIG. 4, the first transmitter 410 and the second transmitter 420 may be separated for the video signal and the audio signal, or may be included in a single transmitter, that is, the transmitter 260.

The first transmitter 410 may pack the video signal encoded by the video encoder 240, and may transmit the video signal to the decoding apparatus 120.

The second transmitter 420 may pack the audio signal encoded by the audio encoder 250, and may transmit the audio signal to the decoding apparatus 120.

FIG. 5 is a block diagram illustrating a configuration of the decoding apparatus 120 of FIG. 1.

Referring to FIG. 5, the decoding apparatus 120 may include a receiver 510, a video decoder 520, an audio decoder 530, a unique information extractor 540, a unique information generator 550, and a synchronizer 560.

The receiver 510 may unpack information from signals received from the encoding apparatus 110, and may extract the encoded audio signal and the encoded video signal. The receiver 510 may transmit the encoded audio signal and the encoded video signal to the audio decoder 530 and the video decoder 520, respectively.

The video decoder 520 may decode the video signal that is encoded and received from the receiver 510.

The audio decoder 530 may decode the audio signal that is encoded and received from the receiver 510.

The unique information extractor 540 may extract the first unique information of the audio signal from the video signal decoded by the video decoder 520. When the encoding apparatus 110 inserts the first unique information of the video signal into the audio signal, the unique information extractor 540 may extract the first unique information of the video signal from the audio signal decoded by the audio decoder 530.

The unique information generator 550 may generate second unique information of the audio signal based on the audio signal decoded by the audio decoder 530. When the encoding apparatus 110 inserts the first unique information of the video signal into the audio signal, the unique information generator 550 may generate second unique information of the video signal based on the video signal decoded by the video decoder 520.

The synchronizer 560 may compare the first unique information of the audio signal to the second unique information of the audio signal, and may determine a delay between the audio signal and the video signal. The synchronizer 560 may synchronize the audio signal and the video signal based on the determined delay.

For example, the synchronizer 560 may search for second unique information of the audio signal matched to the first unique information of the audio signal. To generate the found second unique information, a difference between a frame of the audio signal used by the unique information generator 550 and a frame of the audio signal from which the first unique information is extracted by the unique information extractor 540 may be determined as a delay.

When the encoding apparatus 110 inserts the first unique information of the video signal into the audio signal, the synchronizer 560 may compare the first unique information of the audio signal to the second unique information of the audio signal, may compare the first unique information of the video signal to the second unique information of the video signal, and may determine the delay between the audio signal and the video signal.

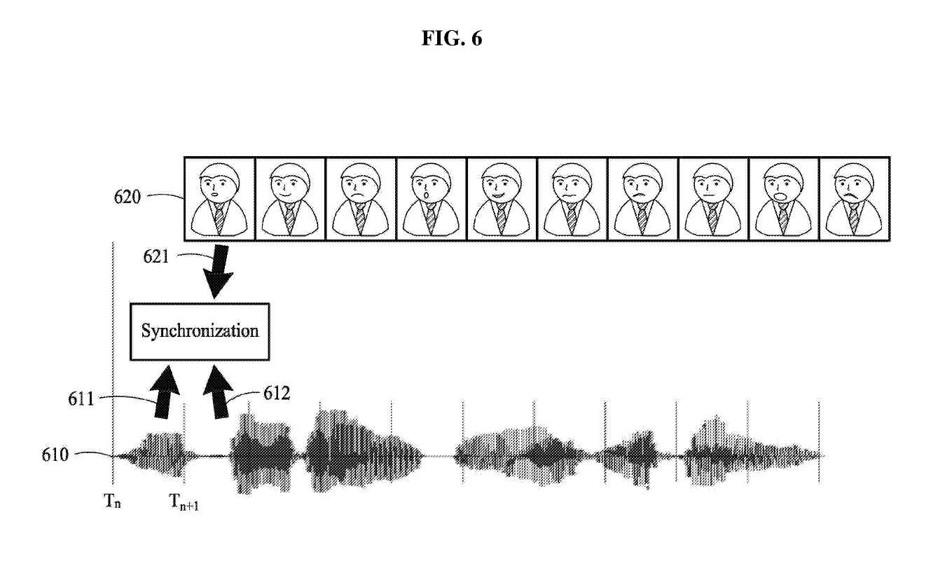

FIG. 6 illustrates an example of an operation of the decoding apparatus 120 of FIG. 1.

Referring to FIG. 6, an audio signal 610 may be received earlier by a single frame than a video signal 620.

The decoding apparatus 120 may generate second unique information 611 based on a first frame of the audio signal 610, and generate second unique information 612 based on a second frame of the audio signal 610.

The decoding apparatus 120 may extract first unique information 621 of an audio signal from a first frame of the video signal 620.

Because the first unique information 621 is generated based on a first frame of an audio signal that is not encoded, the first unique information 621 may be different from the second unique information 612 generated at a point in time at which the first unique information 621 is extracted.

Accordingly, the decoding apparatus 120 may search for the second unique information 611 that is the same as the first unique information 621 from second unique information generated based on frames of the audio signal 610.

A delay between the second unique information 611 and the first unique information 621 may correspond to a single frame, and thus the decoding apparatus 120 may delay an output of the audio signal 610 by a single frame, to perform synchronization with the video signal 620.

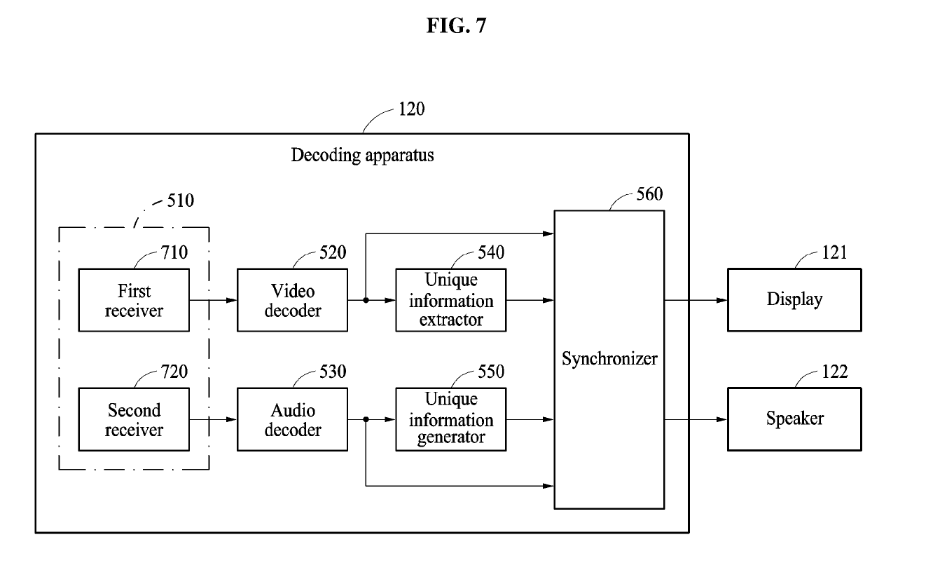

FIG. 7 illustrates an example of an operation between components of the decoding apparatus 120 of FIG. 1. The example of FIG. 7 may correspond to the example of FIG. 4.

The receiver 510 may include a first receiver 710 and a second receiver 720 as shown in FIG. 7.

The first receiver 710 may unpack information from the video signal received from the first transmitter 410 and may extract the encoded video signal. The first receiver 710 may transmit the encoded video signal to the video decoder 520.

The second receiver 720 may unpack information from the audio signal received from the second transmitter 420 and may extract the encoded audio signal. The second receiver 720 may transmit the encoded audio signal to the audio decoder 530.

The video decoder 520 may decode the video signal that is encoded and received from the first receiver 710. The video decoder 520 may transmit the decoded video signal to the unique information extractor 540 and the synchronizer 560.

The audio decoder 530 may decode the audio signal that is encoded and received from the second receiver 720. The audio decoder 530 may transmit the decoded audio signal to the unique information generator 550 and the synchronizer 560.

The unique information extractor 540 may extract the first unique information of the audio signal from the video signal decoded by the video decoder 520. The unique information extractor 540 may transmit the extracted first unique information of the audio signal to the synchronizer 560.

The unique information generator 550 may generate the second unique information of the audio signal based on the audio signal decoded by the audio decoder 530. The unique information generator 550 may transmit the generated second unique information of the audio signal to the synchronizer 560.

The synchronizer 560 may compare the first unique information of the audio signal received from the unique information extractor 540 to the second unique information of the audio signal received from the unique information generator 550, and may determine a delay between the audio signal and the video signal. The synchronizer 560 may synchronize the audio signal received from the audio decoder 530 and the video signal received from the video decoder 520, and may output the audio signal and the video signal to the speaker 122 and the display 121, respectively.

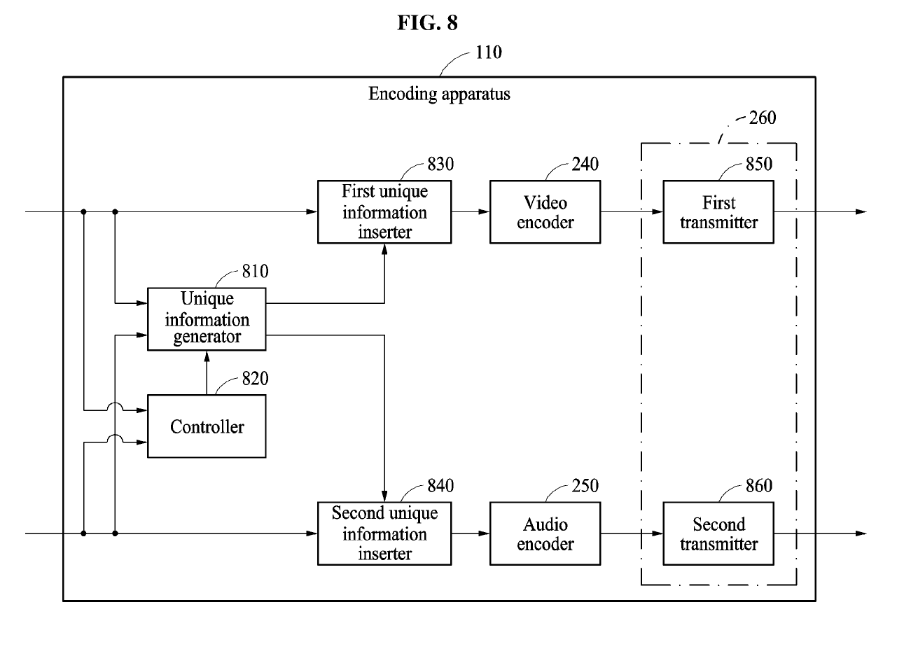

FIG. 8 illustrates another example of an operation between components of the encoding apparatus 110 of FIG. 1.

In the example of FIG. 8, unique information of an audio signal and unique information of a video signal may be generated, encoded, decoded and synchronized.

A first unique information inserter 830 and a second unique information inserter 840 may be included in the unique information inserter 230. Also, a unique information generator 810 may have the same configuration as the unique information generator 210, and a controller 820 may have the same configuration as the controller 220.

The controller 820 may determine an amount of unique information and an interval between frames based on a feature of the audio signal received from the microphone 112 and the video signal received from the camera 111. Also, the controller 820 may determine a frame that is to be used by the unique information generator 810 to generate unique information among frames of the received audio signal and the received video signal, based on an interval between the frames.

The unique information generator 810 may generate the first unique information of the audio signal based on at least one of frames of the audio signal received from the microphone 112 based on a control of the controller 820. The unique information generator 810 may transmit the generated first unique information of the audio signal to the first unique information inserter 830.

Also, the unique information generator 810 may generate the first unique information of the video signal based on at least one of frames of the video signal received from the camera 111 based on the control of the controller 820. The unique information generator 810 may transmit the generated first unique information of the video signal to the second unique information inserter 840.

The first unique information inserter 830 may insert the first unique information of the audio signal received from the unique information generator 810 into the video signal received from the camera 111. The first unique information inserter 830 may transmit the video signal into which the first unique information of the audio signal is inserted to the video encoder 240. The first unique information inserter 830 may use the watermarking technology to insert the first unique information of the audio signal into the video signal.

The second unique information inserter 840 may insert the first unique information of the video signal received from the unique information generator 810 into the audio signal received from the microphone 112. The second unique information inserter 840 may transmit the audio signal into which the first unique information of the video signal is inserted to the audio encoder 250. The second unique information inserter 840 may use the watermarking technology to insert the first unique information of the video signal into the audio signal.

The video encoder 240 may encode the video signal received from the first unique information inserter 830 and may transmit the encoded video signal to a first transmitter 850.

The audio encoder 250 may encode frames of the audio signal received from the second unique information inserter 840 and may transmit the encoded frames to a second transmitter 860.

The first transmitter 850 and the second transmitter 860 may be included in the transmitter 260. As shown in FIG. 8, the first transmitter 850 and the second transmitter 860 may be separated for the video signal and the audio signal, or may be included in a single transmitter, that is, the transmitter 260.

The first transmitter 850 may pack the video signal encoded by the video encoder 240 and may transmit the video signal to the decoding apparatus 120.

The second transmitter 860 may pack the audio signal encoded by the audio encoder 250 and may transmit the audio signal to the decoding apparatus 120.

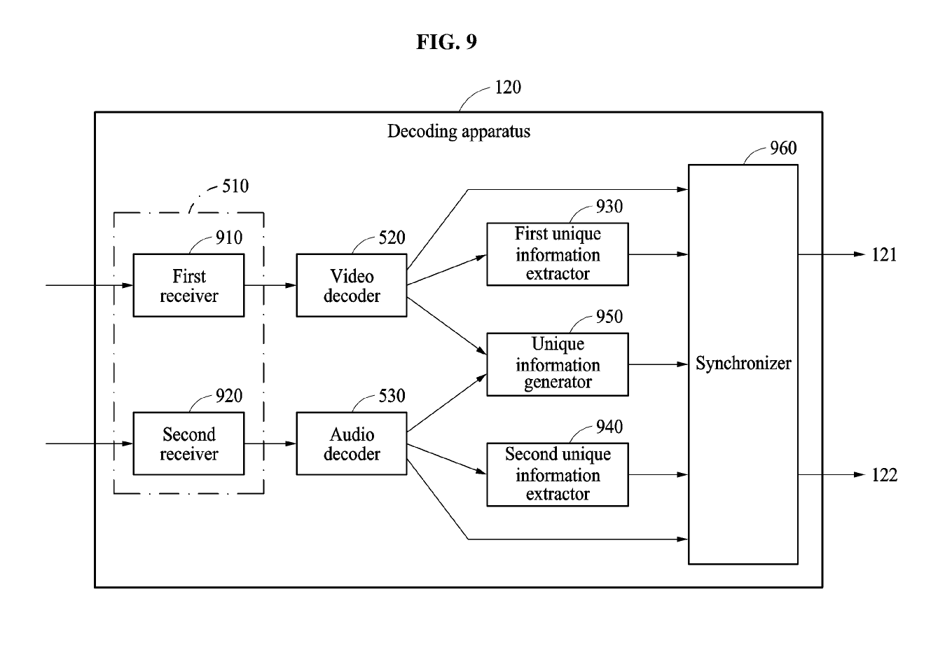

FIG. 9 illustrates another example of an operation between components of the decoding apparatus 120 of FIG. 1. The example of FIG. 9 may correspond to the example of FIG. 8.

A first unique information extractor 930 and a second unique information extractor 940 may be included in the unique information extractor 540. A unique information generator 950 may have the same configuration as the unique information generator 550.

The receiver 510 may include a first receiver 910 and a second receiver 920 as shown in FIG. 9.

The first receiver 910 may unpack information from the video signal received from the first transmitter 850 and may extract the encoded video signal. The first receiver 910 may transmit the encoded video signal to the video decoder 520.

The second receiver 920 may unpack information from the audio signal received from the second transmitter 860 and may extract the encoded audio signal. The second receiver 920 may transmit the encoded audio signal to the audio decoder 530.

The video decoder 520 may decode the video signal that is encoded and received from the first receiver 910. The video decoder 520 may transmit the decoded video signal to the first unique information extractor 930, the unique information generator 950 and a synchronizer 960. The first unique information extractor 930 may extract the first unique information of the audio signal from the video signal decoded by the video decoder 520. The first unique information extractor 930 may transmit the extracted first unique information of the audio signal to the synchronizer 960.

The audio decoder 530 may decode the audio signal that is encoded and received from the second receiver 920. The audio decoder 530 may transmit the decoded audio signal to the second unique information extractor 940, the unique information generator 950 and the synchronizer 960. The second unique information extractor 940 may extract the first unique information of the video signal from the audio signal decoded by the audio decoder 530. The second unique information extractor 940 may transmit the extracted first unique information of the video signal to the synchronizer 960.

The unique information generator 950 may generate the second unique information of the video signal based on the video signal decoded by the video decoder 520. The unique information generator 950 may transmit the generated second unique information of the video signal to the synchronizer 960. Also, the unique information generator 950 may generate the second unique information of the audio signal based on the audio signal decoded by the audio decoder 530. The unique information generator 950 may transmit the generated second unique information of the audio signal to the synchronizer 960.

The synchronizer 960 may compare the first unique information of the audio signal received from the first unique information extractor 930 to the second unique information of the audio signal received from the unique information generator 950, may compare the first unique information of the video signal received from the second unique information extractor 940 to the second unique information of the video signal received from the unique information generator 950, and may determine a delay between the audio signal and the video signal. The synchronizer 960 may synchronize the audio signal received from the audio decoder 530 and the video signal received from the video decoder 520, and may output the audio signal and the video signal to the speaker 122 and the display 121, respectively.

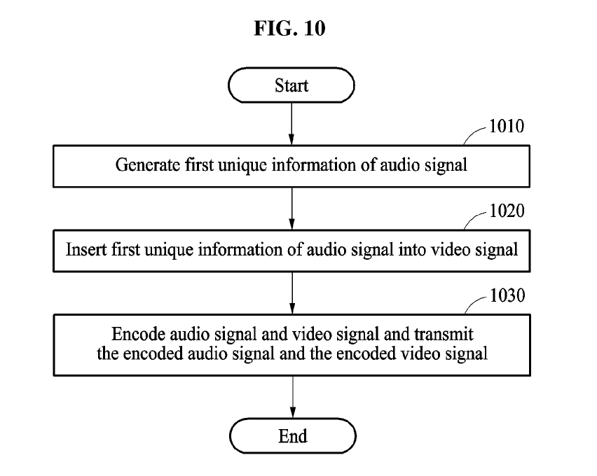

FIG. 10 is a flowchart illustrating an example of an encoding method according to an embodiment.

Referring to FIG. 10, in operation 1010, the unique information generator 210 may generate first unique information of an audio signal received from the microphone 112 based on the audio signal. For example, the unique information generator 210 may determine whether to generate unique information corresponding to a frame of the audio signal based on an interval between frames determined by the controller 220.

In operation 1020, the unique information inserter 230 may insert the first unique information generated in operation 1010 into a video signal based on the control of the controller 220. For example, the unique information inserter 230 may use a watermarking technology to insert the first unique information of the audio signal into the video signal.

In operation 1030, the video encoder 240 may encode the video signal into which the first unique information of the audio signal is inserted by the unique information inserter 230, and the audio encoder 250 may encode the audio signal. In addition, the transmitter 260 may pack the video signal encoded by the video encoder 240 and the audio signal encoded by the audio encoder 250 and may transmit the packed signals to the decoding apparatus 120.

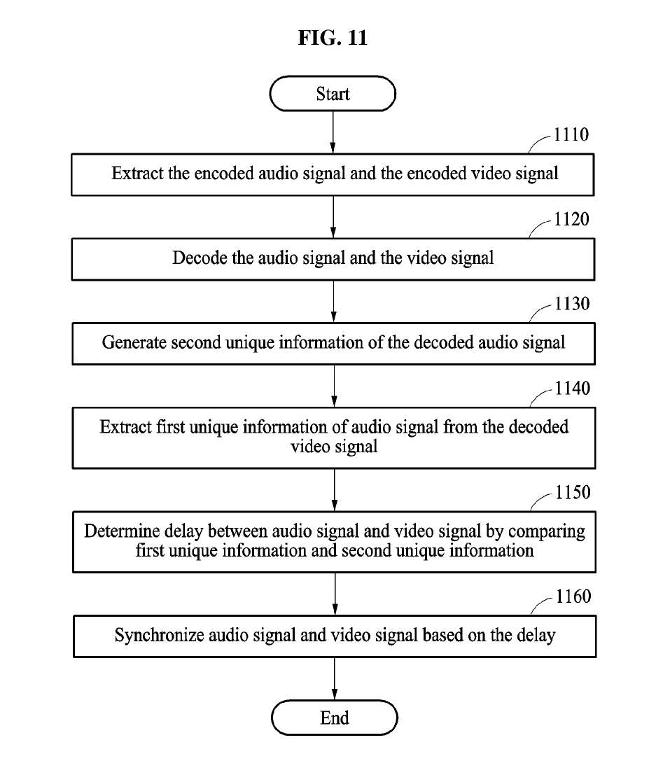

FIG. 11 is a flowchart illustrating an example of a decoding method corresponding to the encoding method of FIG. 10 according to an embodiment.

Referring to FIG. 11, in operation 1110, the receiver 510 may unpack information received from the encoding apparatus 110 in operation 1030 of FIG. 10 and may extract the encoded audio signal and the encoded video signal.

In operation 1120, the video decoder 520 may decode the encoded video signal and the audio decoder 530 may decode the encoded audio signal.

In operation 1130, the unique information generator 550 may generate second unique information of the audio signal based on the audio signal decoded in operation 1120.

In operation 1140, the unique information extractor 540 may extract the first unique information of the audio signal from the video signal decoded in operation 1120.

In operation 1150, the synchronizer 560 may determine a delay between the audio signal and the video signal by comparing the first unique information and the second unique information of the audio signal.

In operation 1160, the synchronizer 560 may synchronize the audio signal and the video signal based on the delay determined in operation 1150.

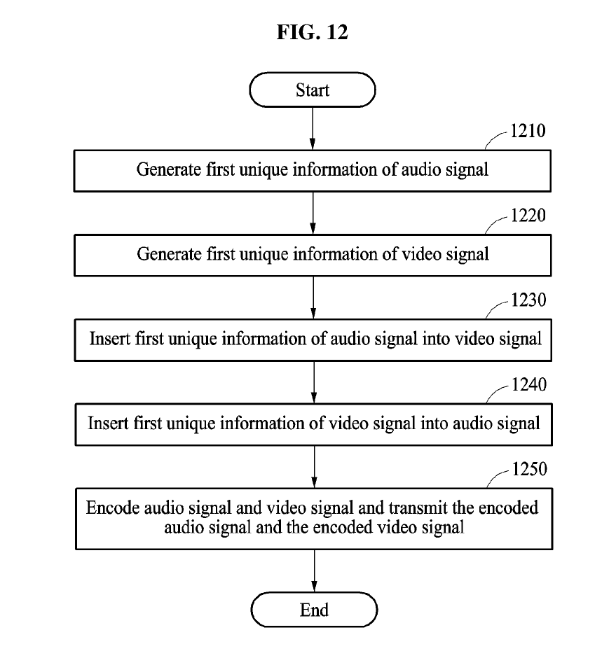

FIG. 12 is a flowchart illustrating another example of an encoding method according to an embodiment.

Referring to FIG. 12, in operation 1210, the unique information generator 210 may generate first unique information of an audio signal received from the microphone 112 based on the audio signal.

In operation 1220, the unique information generator 210 may generate first unique information of a video signal received from the camera 111 based on the video signal.

In operation 1230, the unique information inserter 230 may insert the first unique information generated in operation 1210 into the video signal. For example, the unique information inserter 230 may use a watermarking technology to insert the first unique information of the audio signal into the video signal.

In operation 1240, the unique information inserter 230 may insert the first unique information generated in operation 1220 into the audio signal. For example, the unique information inserter 230 may use the watermarking technology to set the first unique information of the video signal inserted as a watermark into the audio signal so that a user may not listen to the first unique information of the video signal.

In operation 1250, the video encoder 240 may encode the video signal into which the first unique information of the audio signal is inserted in operation 1230. Also, the audio encoder 250 may encode the audio signal into which the first unique information of the video signal is inserted in operation 1240.

In addition, the transmitter 260 may pack the video signal encoded by the video encoder 240 and the audio signal encoded by the audio encoder 250 and may transmit the packed signals to the decoding apparatus 120.

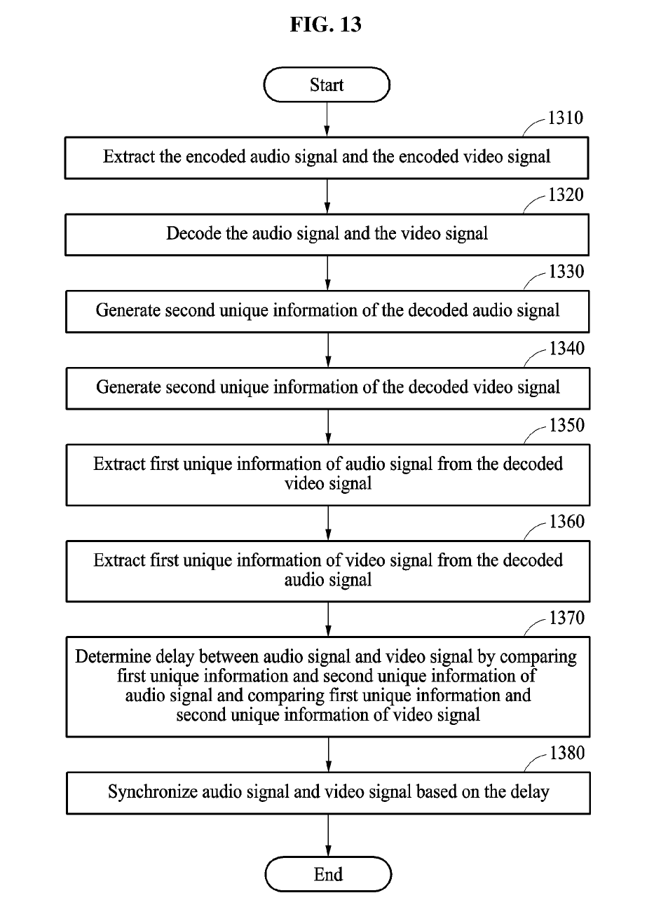

FIG. 13 is a flowchart illustrating an example of a decoding method corresponding to the encoding method of FIG. 12 according to an embodiment.

Referring to FIG. 13, in operation 1310, the receiver 510 may unpack information received from the encoding apparatus 110 in operation 1250 of FIG. 12 and may extract the encoded audio signal and the encoded video signal.

In operation 1320, the video decoder 520 may decode the encoded video signal and the audio decoder 530 may decode the encoded audio signal.

In operation 1330, the unique information generator 550 may generate second unique information of the audio signal based on the audio signal decoded in operation 1320.

In operation 1340, the unique information generator 550 may generate second unique information of the video signal based on the video signal decoded in operation 1320.

In operation 1350, the unique information extractor 540 may extract the first unique information of the audio signal from the video signal decoded in operation 1320.

In operation 1360, the unique information extractor 540 may extract the first unique information of the video signal from the audio signal decoded in operation 1320.

In operation 1370, the synchronizer 560 may determine a delay between the audio signal and the video signal by comparing the first unique information of the audio signal to the second unique information of the audio signal and comparing the first unique information of the video signal to the second unique information of the video signal.

In operation 1380, the synchronizer 560 may synchronize the audio signal and the video signal based on the delay determined in operation 1370.

As described above, according to the embodiments, an encoding apparatus may insert first unique information of an audio signal into a video signal and may transmit the video signal including the first unique information, and a decoding apparatus may decode the audio signal and the video signal and may synchronize the audio signal and the video signal based on a result of a comparison between the first unique information extracted from the decoded video signal and second unique information generated based on the decoded audio signal. Thus, it is possible to prevent a problem from occurring due to a delay of the video signal or the audio signal.

The method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A decoding method comprising:
decoding an audio signal and a video signal received from an encoding apparatus;
extracting first unique information of the audio signal from the decoded video signal;
generating second unique information of the audio signal based on the decoded audio signal;
determining a delay between the audio signal and the video signal by comparing the first unique information to the second unique information; and
synchronizing the audio signal and the video signal based on the delay,
wherein the first unique information is generated based on an audio signal that is not encoded by the encoding apparatus, and is inserted into the video signal.

2. The decoding method of claim 1, wherein the determining of the delay comprises searching for second unique information matched to the first unique information from the generated second unique information and determining, as the delay, a difference between a frame of the audio signal used to generate the found second unique information and a frame of the video signal from which the first unique information is extracted.

3. The decoding method of claim 1, wherein a frame of the video signal into which the first unique information is inserted is determined based on an interval between frames based on a feature of the audio signal and the video signal.

4. The decoding method of claim 1, wherein an amount of the first unique information inserted into the video signal is determined based on a feature of the audio signal and the video signal.

5. The decoding method of claim 1, wherein the first unique information is inserted into a unidirectionally predicted frame (P-frame) or a bidirectionally predicted frame (B -frame) of the video signal based on an encoding feature of the video signal.

6. A decoding method comprising:
decoding an audio signal and a video signal received from an encoding apparatus;
extracting first unique information of the audio signal from the decoded video signal;
extracting first unique information of the video signal from the decoded audio signal;
generating second unique information of the audio signal based on the decoded audio signal;
generating second unique information of the video signal based on the decoded video signal;
determining a delay between the audio signal and the video signal by comparing the first unique information of the audio signal to the second unique information of the audio signal and by comparing the first unique information of the video signal to the second unique information of the video signal; and
synchronizing the audio signal and the video signal based on the delay.

7. The decoding method of claim 6, wherein a frame of the audio signal into which the first unique information of the video signal is inserted is determined based on an interval of frames based on a feature of the audio signal and the video signal.

8. The decoding method of claim 6, wherein an amount of the first unique information of the video signal inserted into the audio signal is determined based on a feature of the audio signal and the video signal.

9. An encoding method comprising:
generating first unique information of an audio signal based on the audio signal;
inserting the first unique information into a video signal; and
encoding the audio signal and the video signal into which the first unique information is inserted.

10. The encoding method of claim 9, wherein the generating of the first unique information comprises determining an interval between frames that are to be used to generate the first unique information, based on a feature of the audio signal and the video signal.

11. The encoding method of claim 9, wherein the generating of the first unique information comprises determining an amount of the first unique information, based on a feature of the audio signal and the video signal.

12. The encoding method of claim 9, wherein the inserting of the first unique information comprises inserting the first unique information into a unidirectionally predicted frame (P-frame) or a bidirectionally predicted frame (B-frame) of the video signal based on an encoding feature of the video signal.
